(19) United States
(12) Patent Application Publication
(10) Pub. No.: US 2010/0284661 A1
(43) Pub. Date: Nov. 11, 2010

(54) SPLICE TRAY CLIP

(75) Inventors: Oscar Fernando Bran de León, Belle Plaine, MN (US); James J. Solheid, Lakeville, MN (US)

Correspondence Address: MERCHANT & GOULD PC, P.O. BOX 2903, MINNEAPOLIS, MN, 55402-0903, US

(73) Assignee: ADC Telecommuncations, Inc., Eden Prairie, MN (US)

(21) Appl. No.: 12/754,801

(22) Filed: Apr. 6, 2010

Related U.S. Application Data
(60) Provisional application No. 61/167,150, filed on Apr. 6, 2009.

(51) Int. Cl. G02B 6/46

(52) U.S. Cl. 385/135; 385/137

(57) ABSTRACT

A retention chip for a splice tray includes a body having a first sidewall and an oppositely disposed second sidewall. The first and second sidewalls cooperatively define a slot that is adapted to receive a loose tube of a fiber optic cable. The first sidewall includes at least one lateral retainer and an axial retainer. The lateral retainer includes a base and a free end. The base is fixed to the first sidewall and the free end extends toward the second sidewall. The axial retainer is oriented generally perpendicular to the lateral retainer.

### CROSS REFERENCE TO RELATED APPLICATION

The present disclosure claims priority to U.S. Patent Application Ser. No. 61/167,150, entitled “Splice Tray Chip” and filed on Apr. 6, 2009, the disclosure of which is hereby incorporated by reference in its entirety.

### BACKGROUND

A wide variety of telecommunication applications utilize fiber optic cables, and in turn involve fiber optic cable splicing and fiber optic cable storage. In these applications, a splice tray is often used to store spliced fiber optic cables. The splice trays commonly include a splice chip for holding or retaining the splice elements of the cables.

In general, improvement has been sought with respect to conventional splice tray arrangements, generally to better accommodate ease of use, to improve reliability of construction, and to increase the density of splice elements that can be stored and managed by the splice tray arrangement.

### SUMMARY

An aspect of the present disclosure relates to retention chip for a splice tray. The retention chip includes a body having a first sidewall and an oppositely disposed second sidewall. The first and second sidewalls cooperatively define a slot that is adapted to receive a loose tube of a fiber optic cable. The first sidewall includes at least one lateral retainer and an axial retainer. The lateral retainer includes a base and a free end. The base is fixed to the first sidewall and the free end extends toward the second sidewall. The axial retainer is oriented generally perpendicular to the lateral retainer.

Another aspect of the present disclosure relates to a splice tray assembly. The splice tray assembly includes a splice tray and a retention chip mounted to the splice tray. The retention chip includes a body having a first sidewall, an oppositely disposed second sidewall and a base wall. The first and second sidewalls and the base wall cooperatively define a slot that is adapted to receive a loose tube of a fiber optic cable. Each of the first and second sidewalls includes at least one lateral retainer and at least one axial retainer. The lateral retainer of the first sidewall being axially offset from the lateral retainer of the second sidewall. Each of the lateral retainers extends into the slot.

Another aspect of the present disclosure relates to a splice tray assembly. The splice tray assembly includes a splice tray and a retention chip mounted to the splice tray. The retention chip includes a body having a plurality of slots. Each of the slots includes a first sidewall, an oppositely disposed second sidewall and a base wall. Each of the first and second sidewalls of each of the slots includes at least one lower lateral retainer, at least one upper lateral retainer and at least one axial retainer. The lower and upper lateral retainers extend into the slot. The lower and upper lateral retainers of the first sidewall are axially offset from the lower and upper lateral retainers of the second sidewall.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DRAWINGS

FIG. 1 is a perspective view of a splice tray stack in a first position having exemplary features of aspects in accordance with the principles of the present disclosure.

FIG. 2 is a side view of the splice tray stack of FIG. 1 in a second position.

FIG. 3 is a perspective view of the splice tray stack of FIG. 2.

FIG. 4 is an enlarged fragmentary view of the splice tray stack of FIG. 3.

FIG. 5 is a perspective view of a chip suitable for use with the splice tray stack of FIG. 1.

FIG. 6 is a right side view of the chip of FIG. 5.

FIG. 7 is an alternate perspective view of the chip of FIG. 5.

FIG. 8 is a top view of the chip of FIG. 5.

FIG. 9 is a front view of the chip of FIG. 5.

FIG. 10 is a bottom view of the chip of FIG. 5.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

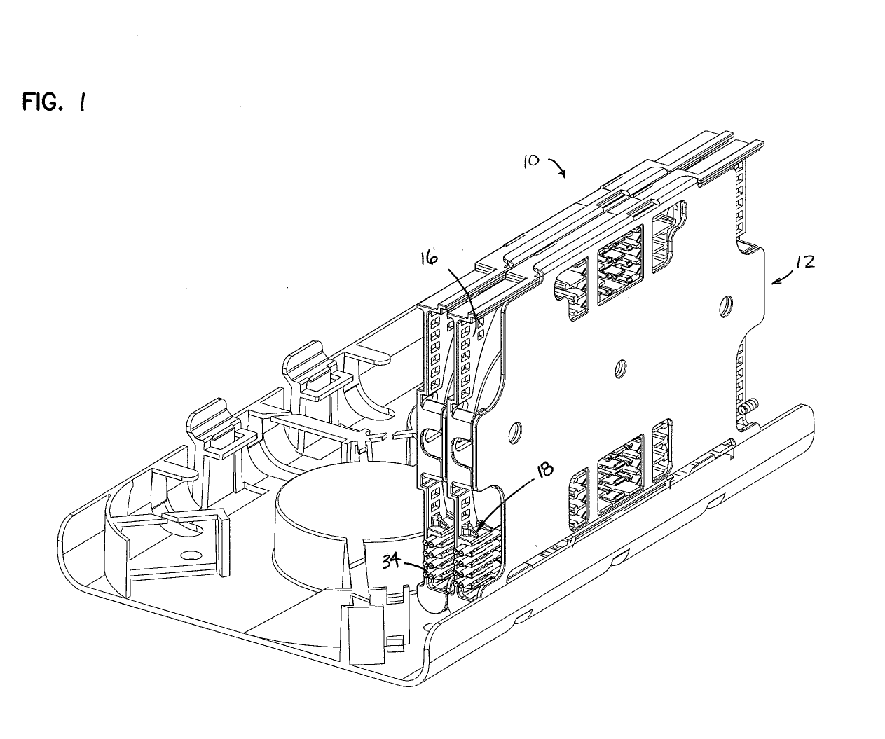

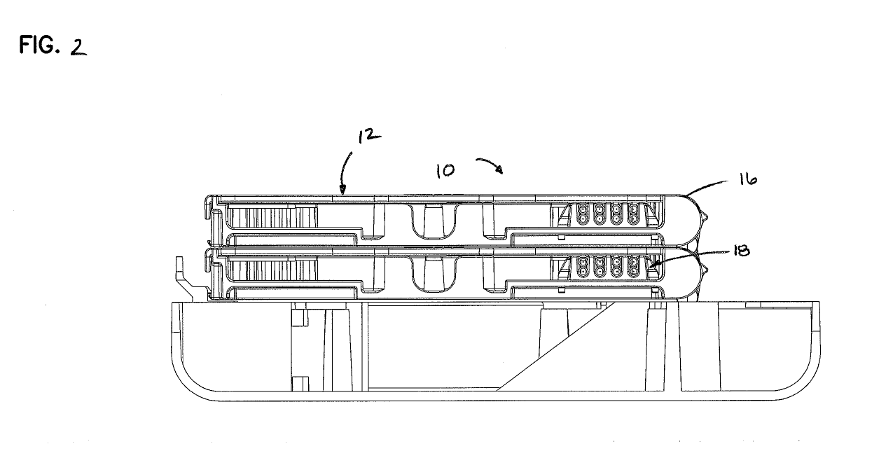

Referring now to FIGS. 1-3, a splice tray stack, generally designated 10, is shown. In one aspect of the present disclosure, the splice tray stack 10 includes a plurality of splice tray assemblies 12. Each of the splice tray assemblies 12 is used to house spliced fiber optic cables.

The splice tray assembly 12 of the present disclosure generally includes a splice tray 16 and a retention chip 18. The retention chip 18 is adapted to hold or retain optical fibers 20 of a fiber optic cable.

An exemplary splice tray stack 10 and splice tray 14 has been described in U.S. Patent Application Ser. Nos. 61/039,045 (now U.S. patent application Ser. No. 12/370,040), which was filed on Mar. 24, 2008, 61/046,678 (now U.S. patent application Ser. No. 12/425,241), which was filed on Apr. 21, 2008, and 61/147,933 (now U.S. patent application Ser. No. 12/425,241), which was filed on Jan. 28, 2009. The disclosures of the above identified applications are hereby incorporated by reference in their entirety.

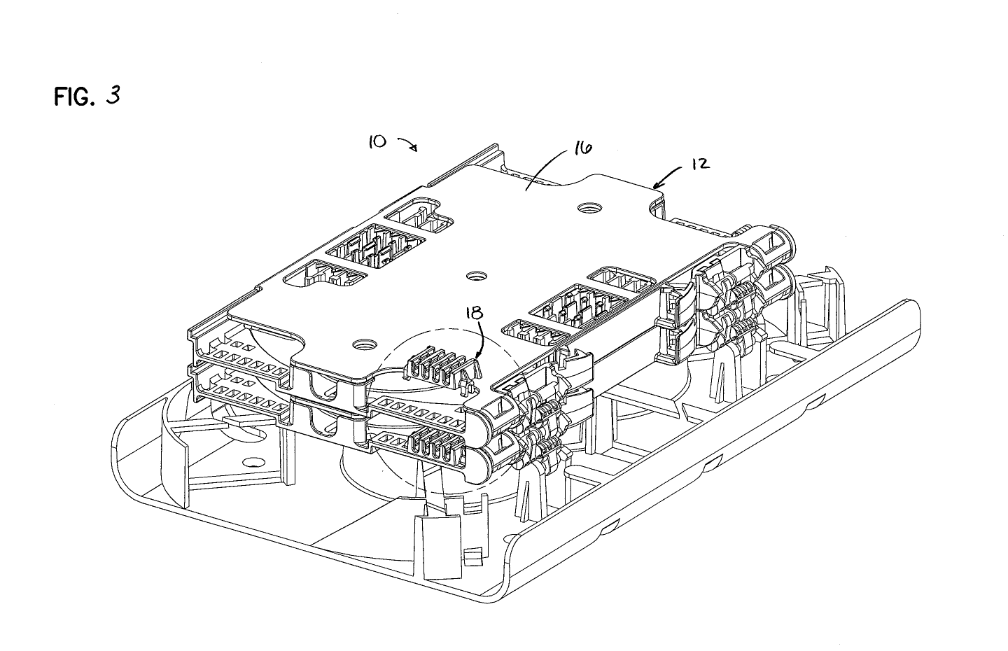

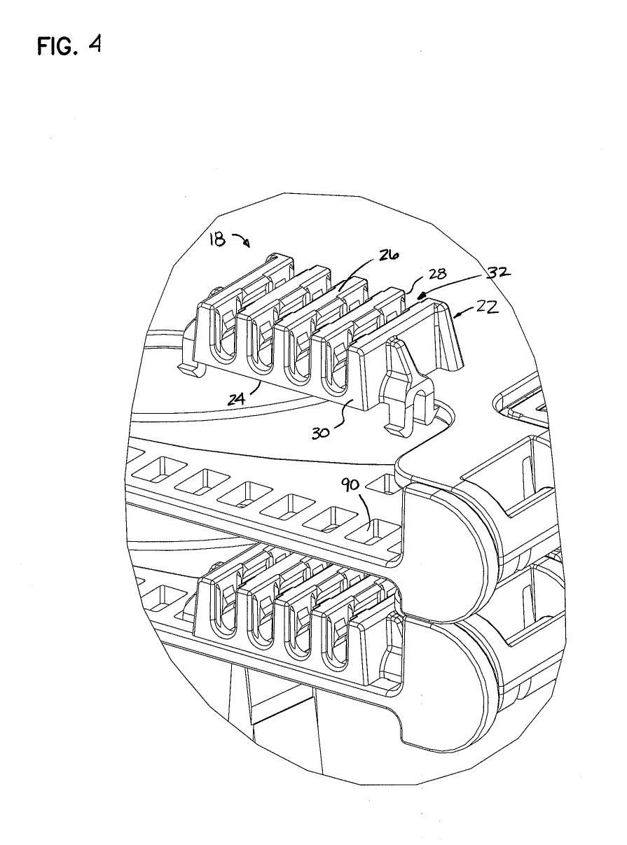

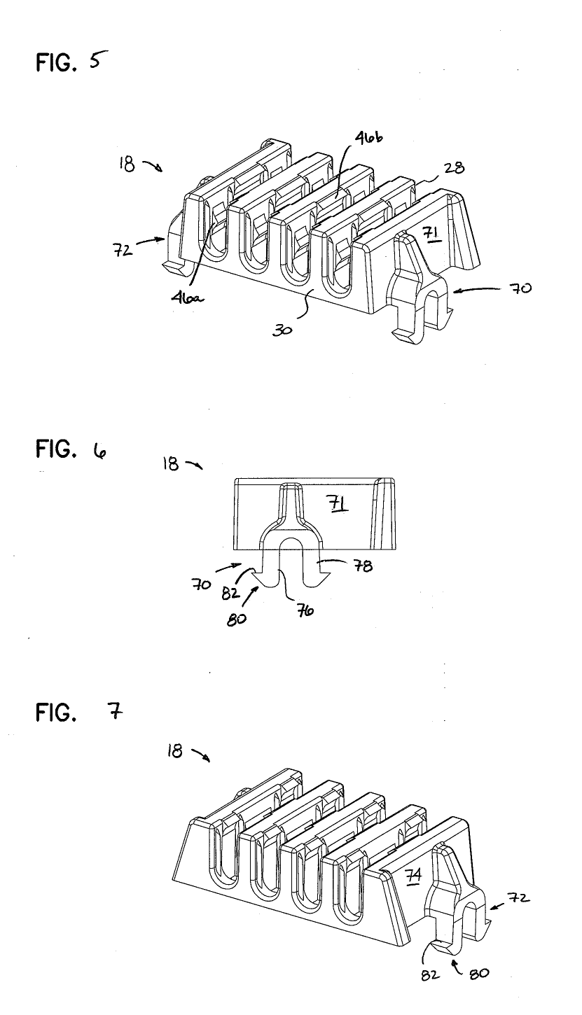

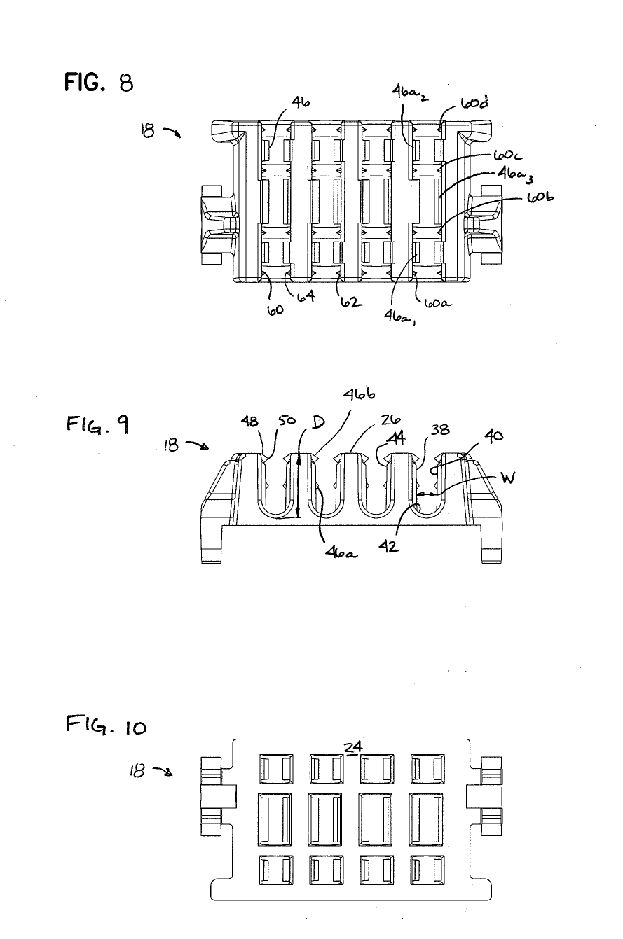

Referring now to FIGS. 4-10, the retention chip 18 is shown. The retention chip 18 includes a body 22. The body 22 includes a lower surface 24, an oppositely disposed upper surface 26, a front side 28, and an oppositely disposed back side 30. The front and back sides 28, 30 extend between the lower and upper surfaces 24, 26. It will be understood that the direction convention used above with regard to the surfaces 24, 26 and the sides 28, 30 is arbitrary and is not intended to limit the present disclosure.

The body 22 defines at least one slot 32 that is adapted for receiving a fiber optic cable. In one aspect of the present disclosure, the at least one slot 32 is adapted for receiving a loose tube 34 (shown in FIG. 1) of a fiber optic cable. In one aspect of the present disclosure, the body 22 defines a plurality of slots 32. In another aspect of the present disclosure, the body 22 defines four slots 32.

In the depicted example of FIGS. 4-10, the slots 32 extend through the front and back sides 28, 30 of the body 22. Each of the slots 32 defines a central axis 36 that extends through the front and back sides 28, 30 of the body.

Each of the slots 32 includes a first sidewall 38, an oppositely disposed second sidewall 40 and a base wall 42. The first and second sidewalls 38, 40 are separated by a width W. In one aspect of the present disclosure, the width W is at least 2 millimeters.

The base wall 42 is disposed a distance D from the upper surface 26 of the body 22. In one aspect of the present disclosure, the distance D is greater than or equal to two times the width W. In one aspect of the present disclosure, the base wall 42 is arcuate in shape. In another aspect of the present disclosure, the base wall 42 defines a full radius R.

Each of the slots 32 includes an opening 44 in the upper surface 26 of the body 22. In one aspect of the present disclosure, the opening 44 extends from the front side 28 to the back side 30.

Each of the first and second sidewalls 38, 40 of the slots 32 includes at least one lateral retainer 46. In one aspect of the present disclosure, the lateral retainers 46 are adapted to reduce the risk of the loose tube 34 being inadvertently removed from the slot 32 through the opening 44.

In the depicted example of FIGS. 4-10, each of the lateral retainers 46 includes a base 48 fixed to one of the first and second sidewalls 38, 40 and a free end 50. The free end 50 extends into the slot 32. In one aspect of the present disclosure, the free end 50 extends into the slot 32 in a direction that is generally perpendicular to the first and/or second sidewall 38, 40. The base 48 of each of the lateral retainers 46 longitudinally extends along the first and second sidewalls 38, 40 in a direction that is parallel to the central axis 36 of the slot 32. In one aspect of the present disclosure, the lateral retainers are V-shaped in cross-section.

In the depicted example of FIGS. 4-10, each of the slots 32 is adapted to receive two loose tubes 34 of a fiber optic cable. The loose tubes 34 of the fiber optic cable are disposed in a stacked arrangement in each of the slots 32. In the depicted example, each of the first and second sidewalls 38, 40 of the slots 32 includes at least one lower lateral retainer 46a and at least one upper lateral retainer 46b. The lower lateral retainer 46a is adapted to retain a first loose tube 34a in the slot 32 while the upper lateral retainer 46b is adapted to retain a second loose tube 34b in the slot 32.

The lower lateral retainer 46a disposed on the first sidewall 38 of the slot 32 is axially offset from the lower lateral retainer 46a disposed on the second sidewall 40 of the slot 32 such that the free end 50 of the lower lateral retainer 46a disposed on the first sidewall 38 is not directly opposite the free end 50 of the lower lateral retainer 46a disposed on the second sidewall 40. This axial offset of the lower lateral retainers 46a prevents the width of the slot 32 from becoming too small to receive the loose tube 34. In the depicted example, the first sidewall 38 includes a first lower lateral retainer 46a₁ disposed adjacent to the front side 28 and a second lower lateral retainer 46a₂ disposed adjacent to the back side 30. The first and second lower lateral retainers 46a₁, 46a₂ are separated by a space. The second sidewall 40 includes a third lower lateral retainer 46a₃ disposed opposite the space between the first and second lower lateral retainers 46a₁, 46a₂ of the first sidewall 38.

Similarly, the upper lateral retainer 46b disposed on the first sidewall 38 of the slot 32 is axially offset from the upper lateral retainer 46b disposed on the second sidewall 40 of the slot 32 such that the free end 50 of the upper lateral retainer 46b disposed on the first sidewall 38 is not directly opposite the free end 50 of the upper lateral retainer 46b disposed on the second sidewall 40. In addition, the upper lateral retainers 46b are axially offset from the lower lateral retainers 46a on each of the first and second sidewalls 38, 40 of the slot 32.

Each of the first and second sidewalls 38, 40 of the slot 32 further includes at least one axial retainer 60. In one aspect of the present disclosure, the axial retainers 60 are adapted to reduce the risk of the loose tube 34 being inadvertently moved in the slot 32 axially in a direction parallel to the central axis 36.

In the depicted example of FIGS. 4-10, each of the axial retainers 60 includes a base end 62 fixed to one of the first and second sidewalls 38, 40 and a free end 64 that extends into the slot 32. In one aspect of the present disclosure, the free end 64 extends into the slot 32 in a direction that is generally perpendicular to the first and/or second sidewall 38, 40. The base end 62 of each of the axial retainers 60 longitudinally extends along the first and second sidewalls 38, 40 in a direction that is generally perpendicular to the central axis 36 of the slot 32. In one aspect of the present disclosure, the axial retainers 60 are V-shaped in cross-section.

The axial retainer 60 disposed on the first sidewall 38 of the slot 32 is axially aligned with the axial retainer 60 disposed on the second sidewall 40 of the slot 32 such that the free end 64 of the axial retainer 60 disposed on the first sidewall 38 is directly opposite the free end 64 of the axial retainer 60 disposed on the second sidewall 40. This axial alignment of the axial retainers 60 on the first and second sidewalls 38, 40 provides an interference fit between the axial retainers 60 and the loose tube 34. The interference fit reduces the risk of the loose tube 34 from inadvertently sliding in the slot 32.

In one aspect of the present disclosure, each slot 32 includes four pair of axial retainers 60. A first pair of axial retainers 60a is disposed between the front side 28 and the first lower lateral retainers 46a₁. A second pair of axial retainers 60b is disposed between the first and third lower lateral retainers 46a₁, 46a₃. A third pair of axial retainers 60c is disposed between the third lower lateral retainers and the second lower lateral retainers 46a₃, 46a₂. A fourth pair of axial retainers 60d is disposed between the second lower lateral retainer 46a₂ and the back side 30.

Referring now to FIGS. 4-7, the body 22 further includes a first retention clip 70 disposed on a right side 71 of the body 22 and a second retention clip 72 disposed on a left side 74 of the body 22. Each of the first and second retention clips 70, 72 include a first resilient tab 76 and a second resilient tab 78. Each of the first and second resilient tabs 76, 78 includes a protrusion portion 80 having a lip 82.

In one aspect of the present disclosure, the first and second resilient tabs 76, 78 are adapted for engagement with an opening 90 (shown in FIG. 4) disposed on a perimeter of the splice tray 14.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A retention chip for a splice tray comprising:
a body having a first sidewall and an oppositely disposed second sidewall, the first and second sidewalls cooperatively defining a slot that is adapted to receive a loose tube of a fiber optic cable, the first sidewall having at least one lateral retainer, the lateral retainer having a base and a free end, the base being fixed to the first sidewall and the free end extending toward the second sidewall, the first sidewall further including an axial retainer, wherein the axial retainer is oriented generally perpendicular to the lateral retainer.

2. The retention chip of claim 1, wherein the second sidewall includes a lateral retainer.

3. The retention chip of claim 2, wherein the lateral retainer of the first sidewall is axially offset from the lateral retainer of the second sidewall.

4. The retention chip of claim 1, wherein the lateral retainer is V-shaped in cross-section.

5. The retention chip of claim 1, wherein the second sidewall includes an axial retainer.

6. The retention chip of claim 5, wherein the axial retainer of the second sidewall is axially aligned with the axial retainer of the first sidewall.

7. The retention chip of claim 1, wherein the axial retainer has a V-shaped cross-section.

8. The retention chip of claim 1, wherein the slot has a width measured between the first and second sidewalls and a depth, the depth being greater than or equal to two times the width.

9. The retention chip of claim 1, wherein the body includes a retention clip having a resilient tab adapted for engagement with a splice tray.

10. A splice tray assembly comprising:
a splice tray;
a retention chip mounted to the splice tray, the retention chip including:
a body having a first sidewall, an oppositely disposed second sidewall and a base wall, the first and second sidewalls and the base wall cooperatively defining a slot that is adapted to receive a loose tube of a fiber optic cable, each of the first and second sidewalls including at least one lateral retainer and at least one axial retainer, the lateral retainer of the first sidewall being axially offset from the lateral retainer of the second sidewall, wherein each of the lateral retainers extends into the slot.

11. The splice tray assembly of claim 10, wherein the orientation of the axial retainers is generally perpendicular to the orientation of the lateral retainers.

12. The splice tray assembly of claim 10, wherein the body includes a retention clip having a resilient tab for mounting the retention chip to the splice tray.

13. The splice tray assembly of claim 12, wherein the resilient tab engages an opening in a perimeter of the splice tray.

14. The splice tray assembly of claim 10, wherein the axial retainer of the second sidewall is axially aligned with the axial retainer of the first sidewall.

15. The splice tray assembly of claim 10, wherein the axial retainer has a V-shaped cross-section.

16. The splice tray assembly of claim 10, wherein the lateral retainer is V-shaped in cross-section.

17. The splice tray assembly of claim 10, wherein the slot has a width measured between the first and second sidewalls and a depth, the depth being greater than or equal to two times the width.

18. A splice tray assembly comprising:
a splice tray;
a retention chip mounted to the splice tray, the retention chip including:
a body having a plurality of slots, each of the slots including a first sidewall, an oppositely disposed second sidewall and a base wall, each of the first and second sidewalls of each of the slots including at least one lower lateral retainer, at least one upper lateral retainer and at least one axial retainer, the lower and upper lateral retainers extending into the slot, the lower and upper lateral retainers of the first sidewall being axially offset from the lower and upper lateral retainers of the second sidewall.

19. The splice tray assembly of claim 18, wherein each of the slots has a width measured between the first and second sidewalls and a depth, the depth being greater than or equal to two times the width.

20. The splice tray assembly of claim 18, wherein the axial retainers of the first and second sidewalls are axially aligned.
